(19) United States
(12) Patent Application Publication
(10) Pub. No.: US 2023/0106113 A1
(43) Pub. Date: Apr. 6, 2023

(54) STORAGE CONTAINER SHELF SECURING SYSTEM

(71) Applicant: Apex Coolers, LLC, Dallas, TX (US)

(72) Inventor: Sean Brennan, Dallas, TX (US)

(21) Appl. No.: 17/990,580

(22) Filed: Nov. 18, 2022

Related U.S. Application Data
(63) Continuation-in-part of application No. 15/997,494, filed on Jun. 4, 2018.
(60) Provisional application No. 63/281,585, filed on Nov. 19, 2021.
(60) Provisional application No. 62/661,143, filed on Apr. 23, 2018.
(60) Provisional application No. 62/514,716, filed on Jun. 2, 2017.

(51) Int. Cl. B60N 3/10; B65D 25/20; B60R 9/06; B60N 3/00

(52) U.S. Cl. CPC B60N 3/103; B65D 25/20; B60R 9/065; B60N 3/002

(57) ABSTRACT

A storage container shelf securing system, in one embodiment, may include a base configured to be coupled to a storage container and a shelf between two shelf arms extending upwardly from the base.

### CROSS-REFERENCE TO RELATED APPLICATIONS

The present application claims the benefit under 35 U.S.C. § 119(e) of U.S. Provisional Patent Application Ser. No. 63/281,585, filed Nov. 19, 2021, entitled “Storage Container Shelf Securing System,” which is hereby incorporated by reference for all purposes. The present application is a continuation-in-part of U.S. patent application Ser. No. 15/997,494, filed Jun. 4, 2018, entitled “Storage Container Securing System,” which claims the benefit under 35 U.S.C. § 119(e) of U.S. Provisional Patent Application Ser. No. 62/661,143, filed Apr. 23, 2018, entitled “Storage Container Securing System,” and of U.S. Provisional Patent Application Ser. No. 62/514,716, filed Jun. 2, 2017, entitled “Storage Container Securing System,” and claims the benefit under 35 U.S.C. § 120 of U.S. Design Patent D840,281, entitled “Slidable Insert,” all of which are hereby incorporated by reference for all purposes.

### BACKGROUND

### Technical Field

This disclosure relates to a system to secure a shelf to a storage container.

### History of Related Art

Coolers and other storage containers are often used in open environments where their contents are accessible to users, such as tailgates and the like. Coolers are often filled with beverages at picnics and similar gatherings. Unfortunately, setting a drink on a lid of a cooler renders the contents of the cooler inaccessible and often results in spilled drinks. It would be beneficial to have a mechanism for securing a shelf to a cooler or other storage container, so that the drinks are secured and the contents of the container are still easily accessible to the container owner.

### SUMMARY OF THE INVENTION

In a first aspect, there is provided a shelf securable to a storage container that includes a base mountable to the storage container, first and second arms extending upwardly from the base, and a shelf connected between the first and second arms. In some embodiments, the storage container may include one or more recesses, wherein the base of the shelf includes first and second brackets configured to slidably fit within the one or more recesses. The base of the shelf may also include a lip configured to be disposed along an upper edge of the storage container, below a lid of the storage container. In a second aspect, the shelf may include a pivotable beverage holder having a plurality of opening therein configured to hold a plurality of beverages.

Other aspects, features, and advantages will become apparent from the following detailed description when taken in conjunction with the accompanying drawings, which are part of this disclosure and which illustrate, by way of example, principles of the inventions disclosed.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 is a perspective view of an embodiment of a storage container shelf securing system secured to an object in accordance with this disclosure;

FIG. 2 is a perspective view of an embodiment of a storage container shelf in accordance with this disclosure; and

FIG. 3 is a side view of a storage container shelf in accordance with this disclosure.

### DETAILED DESCRIPTION

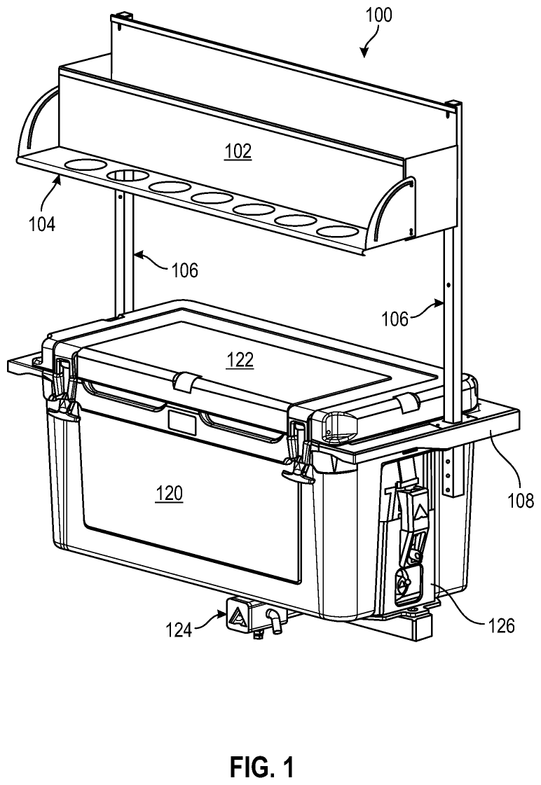

FIG. 1 illustrates an embodiment of a shelf securing system 100 that includes a base 108 for securing one or more shelves 102 to a storage container 122, such as a cooler, toolbox, or other container; one or more shelf arms 106 extending upwardly from the base 108, and a cup holder 104 rotatably coupled to the shelf 102 disposed between the shelf arms 106. In the embodiment shown, the cup holder 104 is in an open position generally perpendicular to the shelf arms 106. In the embodiment shown, the cup holder 104 contains a plurality of holes therein shaped to hold cups, cans, bottles, etc. Similarly, the shelf 102 may be shaped to hold bottles, cups, cans, and other items. The shelf securing system 100 may be configured to be mounted to an upper surface under a lid 122 of the storage container 120, so that the lid 122 of the storage container 120 can be opened and closed so the interior of the storage container 120 is easily accessible to the container owner and other users.

In various embodiments, in addition to not interfering with the opening and closing of the lid 122, the base 108 may also be configured to not interfere with straps, hooks, or other securing devices coupled to the storage container 120. In some embodiments, an insertable bracket 126 may be inserted into slots in the side of the storage container 120, such as the one described in U.S. Pat. No. 8,925,752, entitled “Modular Cooler System,” which is hereby incorporated by reference. In some embodiments, the storage container 120 may be secured to base 124, such as a hitch mount or other surface, using insertable brackets 126 and clamps configured to hook to the storage container 120 without interfering with the opening and closing of the lid 122 as further described in U.S. Pub. Pat. App. No. 2018-0340356, entitled “Storage Container Securing System,” which is hereby incorporated by reference. In such embodiments, the base 108 of the storage container shelf 100 may be configured to be secured to an upper surface of the storage container 120 without interfering with the clamps or insertable brackets 126 utilized to secure the storage container 120 to a base 124 below the storage container 120.

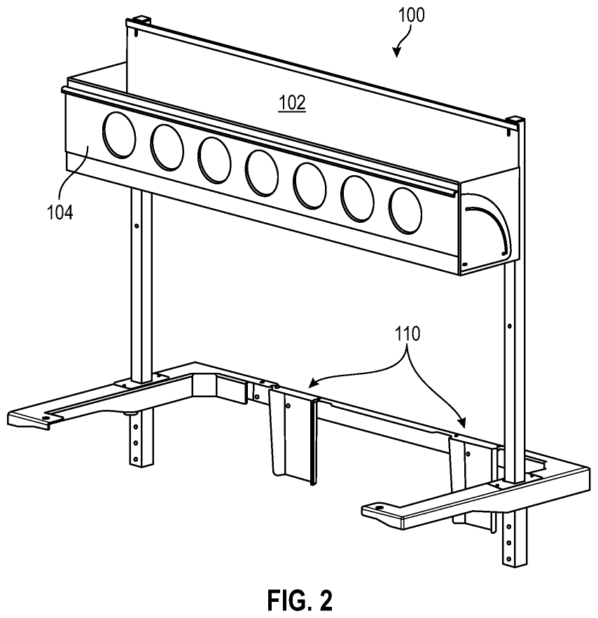

Referring now to FIG. 2, an embodiment of the shelf securing system 100 is shown having support surfaces 110 extending from the base 108. In some embodiments, the support surfaces 110 may be insertable brackets configured to be inserted into slots on a back outer surface of the storage container 120 (not shown). In the embodiment shown, the base 108 is generally U-shaped have tabs extending inwardly from each leg of the U-shaped base 108. The tabs may be configured to insert between the lid 122 and the body of the storage container 120 while the remaining portions of the U-shaped base 108 remains outside the exterior of the storage container 120. In other embodiments, the legs of the U-shaped base 108 may be configured to be inserted between the upper lip of the container 120 and the lid 122. In such embodiments, the shelf arms 106 would be coupled to a portion of the base 108 that protruded out from under the lid a sufficient distance to allow the lid 122 to freely move between the open and closed positions. In the embodiment shown, the cup holder 104 is in a closed position generally parallel to the shelf arms 106. In the embodiment shown, the shelf arms 106 contain openings spaced apart along a lower portion thereof to facilitate adjusting the height of the shelf higher or lower relative to the base 108. In the embodiment shown, the shelf arms 106 contain additional attachment points to facilitate attaching the shelf 102 at a lower location or to facilitate attaching a second shelf (not shown) below the first shelf 102.

In some embodiments, the base 108 may be adjustable such that the legs of the U-shaped base may be secured closer together or farther apart depending on the specifications of the storage container 120. In other embodiments, the portion of the base 108 contacting the upper lip of the storage container may include both legs as well as some across the back of the storage container and/or some across the front of the storage container. In other embodiments, the base 108 has other shapes and sizes to conform to the shape and size of various storage containers, such as coolers, plastic containers, metal containers, or other containers with or without recesses on a back surface thereof.

The foregoing describes only some embodiments of the invention(s), and alterations, modifications, additions and/or changes can be made thereto without departing from the scope and spirit of the disclosed embodiments, the embodiments being illustrative and not restrictive. For example, while in some embodiments a user couples the shelf securing system 100 to a storage container, in other embodiments some of the components of the securing system 100 could be coupled to other surfaces, such as, directly to a trailer hitch or the bed of a pickup truck.

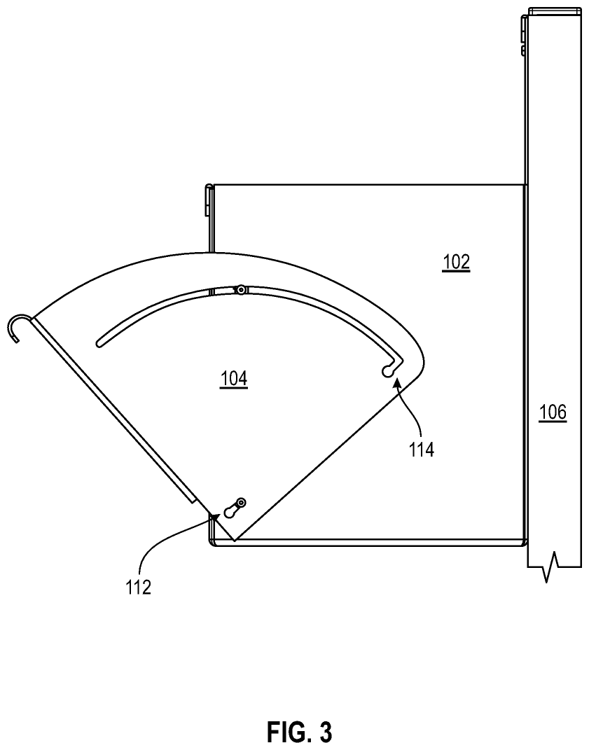

Referring now to FIG. 3, a side view of the cup holder 104 and shelf 102 of the shelf securing system 100. As can be seen, the shelf 102 in this embodiment and includes protrusions, such as pins, rivets, screws, etc., for facilitating the installation and removal of the cup holder 104. In the embodiment shown, the outer side surfaces of the shelf 102 each have two protrusions near a front edge thereof and the cup holder 104 has two keyhole-type cutouts spaced the same distance as the protrusions so that the cup holder 104 can be installed or removed from the shelf 102. Additionally, once installed, a curved cutout allows the cup holder 104 to be opened and closed. In some embodiments, the shelf arms 106 may contain protrusions similar to those on the shelf 102 and a back surface of the shelf 102 may contain keyholes similar to the lower keyhole on the cup holder 104 to facilitate installing and removing the shelf 102 from the shelf arms 106 or installing the shelf 102 at various locations along the shelf arms 106.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and “right”, “front” and “rear”, “top” and “bottom” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

Furthermore, invention(s) have been described in connection with what are presently considered to be the most practical and preferred embodiments and it is to be understood that the inventions are not to be limited to the disclosed embodiments, but on the contrary, are intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A storage container shelf securing system, comprising:
a base having a first leg, a second leg, and a middle section extending between the first and second legs forming a generally U-shape;
a first arm having a lower portion coupled to the first leg of the base and extending upwardly therefrom;
a second arm having a lower portion coupled to the second leg of the base and extending upwardly therefrom;
two insertable brackets extending downwardly from the middle section of the base;
a shelf extending between an upper portion of the first arm and an upper portion of the second arm;
wherein the base is configured to be secured to a storage container having a lid movable between an open position and a closed position; and
wherein the two insertable brackets are configured to be inserted into slots in an exterior surface of the storage container to secure the base to the storage container.

2. The storage container shelf securing system of claim 1, wherein each of the insertable brackets has flanges extending from opposite sides thereof to matingly engage sides of the slots in the exterior surface of the storage container.

3. The storage container shelf securing system of claim 1, comprising:
at least one protrusion extending from a front surface of each of the first arm and the second arm; and
wherein the shelf comprises at least two spaced apart keyholes on a back surface thereof to facilitate insertion of the protrusions therethrough to secure the shelf to the shelf arms.

4. The storage container shelf securing system of claim 1, comprising:
a cup holder coupled to the shelf.

5. The storage container shelf securing system of claim 1 wherein the cup holder is rotatable between open and closed positions.

6. The storage container shelf securing system of claim 1, comprising:
at least one protrusion extending from an outer surface of a first side of the shelf and at least one protrusion extending from an outer surface of a second side of the shelf opposite the first side;
wherein the cup holder comprises first and second side surfaces extending generally perpendicularly from opposites ends thereof; and
wherein the cup holder comprises at least one keyhole on the first side surface thereof and at least one keyhole on the second side surface thereof to facilitate insertion of the protrusions on the outer surfaces of the shelf through the keyholes to secure the cup holder thereto.

7. A storage container shelf securing system, comprising:
a generally U-shaped base having two arms extending upwardly therefrom and at least one support surface extending downwardly therefrom;
a shelf extending between the two arms;
a cup holder coupled to the shelf;
wherein the U-shaped base is configured to be secured to a storage container having a lid movable between an open position and a closed position; and
wherein, when secured to the storage container, at least a portion of the U-shaped base is disposed between an upper surface of the storage container and a lower surface of the lid and the at least one support surface abuts an exterior surface of the storage container.

8. The storage container shelf securing system of claim 7, comprising:
at least one protrusion extending from a front surface of each of the arms; and
wherein the shelf comprises at least two keyholes on a back surface thereof spaced apart to facilitate insertion of the protrusions therethrough to secure the shelf to the shelf arms.

9. The storage container shelf securing system of claim 7 wherein the cup holder is rotatable between open and closed positions.

10. The storage container shelf securing system of claim 7, comprising:
at least one protrusion extending from an outer surface of a first side of the shelf and at least one protrusion extending from an outer surface of a second side of the shelf opposite the first side;
wherein the cup holder comprises first and second side surfaces on opposites ends thereof and generally perpendicular thereto; and
wherein the cup holder comprises at least one keyhole on the first side surface thereof and at least one keyhole on the second side surface thereof to facilitate insertion of the protrusions on the outer surfaces of the shelf through the keyholes to secure the cup holder thereto.

11. The storage container shelf securing system of claim 1 wherein the at least one support surface has flanges extending from opposite sides thereof, the flanges configured to be inserted into a slot on the exterior surface of the storage container when the base is secured to the storage container.
